(19) United States
(12) Patent Application Publication
(10) Pub. No.: US 2014/0261305 A1
(43) Pub. Date: Sep. 18, 2014

(54) METHOD AND DEVICE FOR OPERATING AN INTERNAL COMBUSTION ENGINE

(71) Applicants: Klaus Joos, Walheim (DE); Thomas Moessner, Birkenfeld (DE); Ruben Schlueter, Kanagawa (JP); Markus Amler, Leonberg-Gebersheim (DE); Axel Storch, Besigheim (DE); Michael Wunderle, Ostfildern (DE); Matthias Weinmann, Balingen (DE)

(72) Inventors: Klaus Joos, Walheim (DE); Thomas Moessner, Birkenfeld (DE); Ruben Schlueter, Kanagawa (JP); Markus Amler, Leonberg-Gebersheim (DE); Axel Storch, Besigheim (DE); Michael Wunderle, Ostfildern (DE); Matthias Weinmann, Balingen (DE)

(21) Appl. No.: 14/237,843

(22) PCT Filed: Jul. 3, 2012
(86) PCT No.: PCT/EP2012/062940

§ 371 Date: May 23, 2014

(30) Foreign Application Priority Data
Aug. 15, 2011 (DE) 102011080963.5

(51) Int. Cl. F02D 41/30

(52) U.S. Cl. CPC F02D 41/30
USPC 123/299

(57) ABSTRACT

In a method for operating an internal combustion engine during a catalytic converter heating phase, fuel in at least two portions is injected directly into at least one combustion chamber, a first portion of the fuel being injected during an intake stroke and an injection of a second portion of the fuel taking place directly before an ignition. The second portion is continuously reduced until a freely selectable boundary value of a torque fluctuation has been reached.

### BACKGROUND OF THE INVENTION

1. Field of the Invention

The present invention relates to a method and a control device for operating an internal combustion engine.

2. Description of the Related Art

In order rapidly to achieve the operating temperature of catalytic converters, it is known that one may heat up the catalytic converter directly after the start of the internal combustion engine, in a targeted manner, by a special injection method.

An injection method is known from published German patent application document DE 10 2006 016 037 A1, in which, during a compression stroke, the fuel is introduced by at least two partial injections, the major portion of the fuel quantity being first introduced in a so-called main injection (which may also be implemented by multiple injection). Subsequently, immediately before ignition, a small portion of the fuel quantity is injected. This fuel quantity does not contribute substantially to the torque and also does not substantially increase fuel consumption. Using this small partial quantity, a rich mixture is produced in a region directly close to the spark plug, so that after the ignition, a so-called “ignition torch” comes about in the combustion chamber which reliably ignites the remaining lean mixture.

The ignition torch is important in two respects for the combustion during the catalytic converter heating phase. Besides the above desired stability of the combustion, it may also cause undesired particulate emissions. If the partial quantity of the fuel injected to achieve the ignition torch is selected to be too small, the remaining lean mixture is not reliably ignited, and as a result it burns only incompletely. If, on the other hand, the injection quantity is too large, the piston standing shortly before the ignition, close to its top dead center is wetted. In this case, the result is incomplete combustion and the formation of soot particles which are exhausted along with the exhaust gas.

As a result, the catalytic converter heating phase requires great metering accuracy of small fuel quantities. However, known methods for calibrating injectors are frequently limited in their accuracy, especially in the case of small injection quantities.

### BRIEF SUMMARY OF THE INVENTION

The method according to the present invention enables the calibration individual for each cylinder of small injection quantities in a catalytic converter heating phase. This makes possible the application of higher pressures and smaller injection quantities during the catalytic converter heating, which has an advantageous effect on particulate emissions. In overall terms, an optimum catalytic converter heating phase is ensured. In this context, the method according to the present invention utilizes data already present, which the sensors and actuators of the internal combustion engine supply to the regulating unit and the control unit. Consequently, no additional hardware is required to carry out the method according to the present invention.

According to the present invention, during the catalytic converter heating phase, the fuel quantity injected into a cylinder to form the ignition torch (also designated as ignition injection quantity) is diminished continuously, until it is no longer sufficient to achieve a sufficiently good combustion of the remaining lean mixture of fuel and air in the combustion chamber. If no combustion or only an incomplete one of the fuel/air mixture is taking place in the combustion chamber, this cylinder contributes little or nothing to the torque produced overall by the internal combustion engine. Torque fluctuations occurring in such a way express themselves as so-called unsteady running or rotational speed fluctuations and are able to be detected by monitoring the rotational speed of the engine.

The method according to the present invention works on the assumption that an ignition injection quantity, which is still just sufficient to form an ignition torch, satisfies the requirement for the least possible wetting of the piston. The less the wetting of the piston, the less is the formation of soot during the combustion process, and the less the particulate emitted with the exhaust gas. Thus, the present invention achieves an optimum between reduced particulate emission and steady running of the internal combustion engine that the driver is able to perceive.

One additional embodiment of the method according to the present invention provides that the ignition injection quantity be continuously reduced until a desired pressure characteristic is achieved in the combustion chamber. In order to ensure steady running, some internal combustion engines evaluate the data of a pressure sensor situated in the combustion chamber. In this case, the ignition injection quantity may be reduced until a desired pressure characteristic sets in. In this way, steady running is ensured, and the particulate emissions are simultaneously reduced.

It is furthermore provided that the minimum actuation duration ascertained by the method according to the present invention be used for subsequent injections. The actuation duration of an actuator of the injector is proportional to the fuel quantity injected. If a minimum ignition injection quantity is ascertained, it correlates with a minimum actuation duration, as was explained before. This minimum actuation duration is stored, and subsequent injections are based on it. In this way, a high metering accuracy is ensured, especially for small injection quantities. Once the minimum actuation duration has been ascertained for one injector, the minimum ignition injection quantity for the next cylinder of the internal combustion engine is subsequently determined, or rather, the minimum actuation duration of the associated injector. The procedure according to the present invention is made possible or at least made easier by greatly restricted operating conditions during the catalytic converter heating phase. Thus, for example, the pressure in the rail is held constant and also the sequence over time of the injections is not changed, or changed only slightly during the catalytic converter heating phase.

It is additionally provided that the minimum actuation duration be continuously monitored. The monitoring of the minimum actuation duration may be done, for example, by comparing a current, newly ascertained minimum actuation duration to a value already stored. A deviation occurring in this context permits, for instance, conclusions with respect to aging effects of the injector, and may also be used to compensate for these aging effects. The deviation thus ascertained is used for calibrating the injector, and thereby increases the operating safety of the internal combustion engine.

It is particularly helpful that the sum of the fuel quantities injected in the main injection and the ignition injection is constant. In this connection, the fuel quantity injected in the ignition injection is deducted from the overall fuel quantity that is to be injected into the combustion chamber. This effectively prevents an increase in the fuel consumption by the catalytic converter heating phase.

### BRIEF DESCRIPTION OF THE DRAWINGS

FIG. 1 shows a schematic representation of an internal combustion engine having a plurality of cylinders each having one combustion chamber.

FIG. 2 shows a flow chart of the method according to the present invention.

### DETAILED DESCRIPTION OF THE INVENTION

In FIG. 1, an internal combustion engine is designated overall by reference numeral 10. It is used to drive a motor vehicle, not shown, and includes four essentially identical cylinders 12a to 12d having four combustion chambers 14a to 14d. Each combustion chamber 14a to 14d has an intake valve 16a to 16d, which are connected to an intake manifold 18. Via intake manifold 18 and intake valves 16a to 16d, combustion air gets to the respective combustion chamber 14a to 14d. Fuel is injected into combustion chambers 14a to 14d via one injector 20a to 20d, respectively. Injectors 20a to 20d are connected to a rail, not shown, in which fuel is stored under high pressure.

The fuel/air mixture located in combustion chambers 14a to 14d is ignited by a spark plug 22a to 22d, respectively. The hot combustion gases are led from combustion chambers 14a to 14d into an exhaust gas pipe 26 via outlet valves 24a ro 24d. This leads to catalytic converter system 28, which purifies the exhaust gas by chemical conversion of the harmful materials contained in it.

The operation of internal combustion engine 10 is controlled and regulated by a control device and regulating device 30, which receives signals from various sensors and actuators of internal combustion engine 10 that are not shown, however, in FIG. 1.

After a start phase that usually lasts about 1 to 2 seconds, that is, after the very first injections and ignitions, there follows a catalytic converter heating phase. In this context, a first portion of the fuel is injected, during an intake stroke of the respective cylinder 12a to 12d by the respective injector 20a to 20d into combustion chamber 14, so that there a lean, homogeneous fuel/air mixture is formed. A second portion of the fuel quantity is injected into combustion chamber 14 towards the end of the compression stroke, that is, shortly before ignition by a spark plug 22. Thereby there is developed a rich fuel/air mixture cloud, a so-called ignition torch, in the vicinity of spark plug 22. During the ignition of the ignition torch, turbulences are created which ensure thorough mixing and thereby reliable inflaming of the lean, homogeneous fuel/air mixture.

According to the present invention, it is provided, during the catalytic converter heating phase, that one reduce the second portion of the fuel quantity successively to the point until the ignition torch is just still sufficient certainly to inflame the lean, homogeneous fuel/air mixture in the combustion chamber. If the second portion of the fuel quantity is reduced too much, the energy of the ignition torch will no longer be sufficient to inflame the lean, homogeneous fuel/air mixture completely. This state is able to be detected as a pressure characteristic in cylinder 12 or a fluctuation in the rotational speed of the internal combustion engine. In the figure, a corresponding sensor bears reference numeral 31.

The injected fuel quantity correlates with the actuation duration of respective injector 20. As was described above, if the minimum fuel quantity, and, with that, also a minimum actuation duration of injector 20 is ascertained during the second portion of the injection, the minimum actuation duration is stored in the control device and/or regulating device 30 and used for subsequent injections.

The method according to the present invention is used successively for each injector 20a to 20d. Continuous monitoring of the minimum actuation duration also permits compensation for aging effects of injector 20.

FIG. 2 shows the sequence of the inventive method in a block diagram.

When the cooling water of internal combustion engine 10 is cold at the start, a so-called cold start takes place. A catalytic converter heating phase is a part of this, among other things. The method according to the present invention relates to the catalytic converter heating phase. Therefore, the block diagram begins with a block 32, which represents the catalytic converter heating phase.

In subsequent block 34, the fuel quantity injected during the ignition injection into one of cylinders 12a to 12d is reduced. In interrogating block 36, it is checked whether the unsteady running resulting from the reduced fuel quantity injected during the ignition injection, or rather the torque fluctuation, exceeds a value that is still just acceptable. Alternatively or in supplement, it may also be checked whether the deviations, that are occurring, from a setpoint rotational speed deviation or from a setpoint pressure characteristic in corresponding cylinder 12a to 12d are greater than a previously determined threshold value.

If this is not the case, the fuel quantity injected into one of cylinders 12a to 12d in step 34 during the ignition injection is further reduced by a predetermined quantity. This step-wise reduction of the fuel quantity injected during the ignition injection takes place by a shortening of the actuation duration of the injector, and is continued until one of the abovementioned threshold values has been reached or exceeded.

If the threshold value is reached or exceeded, in step 38, the actuation duration of the injector associated with the injected fuel quantity, is stored for further use. In this context, it is possible to store the actuation duration at which, for the first time, the threshold value has been exceeded or to store the actuation duration at which the threshold value has just barely not been reached or exceeded. The two alternatives are technically equivalent.

If the internal combustion engine has pressure sensors in the combustion chambers, alternatively the pressure characteristic measured by these sensors may also be compared to a specified pressure characteristic. As soon as a sufficiently great agreement between the actual pressure characteristic and the specified pressure characteristic has been reached, it is assumed that a stable ignition torch is still just forming. The actuation duration of the injector used for this is stored and used for subsequent ignition injections.

Finally, in an interrogating block 40, it is checked whether an additional cylinder 12 is still to be measured. If this is the case, beginning with step 34, the method according to the present invention is carried out for a next cylinder 12a to 12d. If, for example, cylinder 12a was measured first, cylinders 12b, 12c and 12d are subsequently measured one after the other. When all the cylinders 12a to 12d have been measured, the method according to the present invention ends at step 42.

The method according to the present invention is repeated at regular, specified intervals in order to compensate for aging signs and/or signs of wear on injectors 20. Thus, after 100 cold starts, for example, or 100 operating hours of the internal combustion engine, the method according to the present invention may be carried out anew.

1-9. (canceled)

10. A method for operating an internal combustion engine, comprising:
injecting fuel, during a catalytic converter heating phase, in at least two injection portions including a main injection and an ignition injection directly into a combustion chamber, wherein the main injection takes place during an intake stroke and the ignition injection takes place before an ignition, and wherein the fuel quantity injected during the ignition injection is reduced step-wise until one of (i) a predefined threshold value of a torque fluctuation has been reached, or (ii) a predefined pressure characteristic has been reached in the combustion chamber.

11. The method as recited in claim 10, wherein the threshold value of the torque fluctuation and the pressure characteristic are freely selectable.

12. The method as recited in claim 10, wherein a minimum actuation duration of an injector associated with one of (i) reaching the predefined threshold value of the torque fluctuation or (ii) achieving the predefined pressure characteristic in the combustion chamber is stored during the ignition injection, and the stored minimum actuation duration is used for subsequent ignition injections.

13. The method as recited in claim 12, wherein the minimum actuation duration during the operation of the internal combustion engine is monitored one of continuously or at predefined intervals.

14. The method as recited in claim 12, wherein the sum of the fuel quantities injected in the main injection and the ignition injection is constant.

15. A non-transitory, computer-readable data storage medium storing a computer program having program codes which, when executed on a computer, perform a method for operating an internal combustion engine, the method comprising:
injecting fuel, during a catalytic converter heating phase, in at least two injection portions including a main injection and an ignition injection directly into a combustion chamber, wherein the main injection takes place during an intake stroke and the ignition injection takes place before an ignition, and wherein the fuel quantity injected during the ignition injection is reduced step-wise until one of (i) a predefined threshold value of a torque fluctuation has been reached, or (ii) a predefined pressure characteristic has been reached in the combustion chamber.

16. A control device for an internal combustion engine, comprising:
a processor for controlling injection of fuel, during a catalytic converter heating phase, in at least two injection portions including a main injection and an ignition injection directly into a combustion chamber, wherein the main injection takes place during an intake stroke and the ignition injection takes place before an ignition, and wherein the fuel quantity injected during the ignition injection is reduced step-wise until one of (i) a predefined threshold value of a torque fluctuation has been reached, or (ii) a predefined pressure characteristic has been reached in the combustion chamber.
